(19) United States
(12) Patent Application Publication
(10) Pub. No.: US 2022/0123535 A1
(43) Pub. Date: Apr. 21, 2022

(54) CUTTING TOOL FOR CABLE SHEATHING

(71) Applicant: Ripley Tools, LLC, Cleveland, OH (US)

(72) Inventors: Will Eisele, Cromwell, CT (US); Brian Bourgoin, Cromwell, CT (US)

(21) Appl. No.: 17/504,843

(22) Filed: Oct. 19, 2021

Related U.S. Application Data
(60) Provisional application No. 63/093,567, filed on Oct. 19, 2020.

(51) Int. Cl. H02G 1/12

(52) U.S. Cl. CPC H02G 1/1236

(57) ABSTRACT

A tool for scoring cable sheathing on a cable including a blade housing assembly having a blade housing, a blade housing opening, a blade disposed in the blade housing opening and a blade housing carrier having a blade housing carrier opening wherein the blade housing is rotatably secured in the blade housing carrier opening for scoring the sheathing in a circular, lateral or spiral direction. The tool includes a cable support member and an adjustable frame disposed between the cable support member and the blade housing assembly for adjusting the cable support member toward and away from the blade housing assembly for scoring various diameter cables, the blade housing carrier secured to one end of the adjustable frame. The blade is adjustable within the blade housing opening toward and away from the cable support member for controlling a depth of the blade into the cable sheathing.

### RELATED APPLICATION

The present application claims priority to provisional patent application Ser. No. 63/093,567, the provisional application being herby incorporated by reference.

### BACKGROUND OF THE INVENTION

### 1. Field of the Invention

The present invention is directed to a cutting tool for cable sheathing for stripping insulation from the conductor core at the end or midspan in an electrical power cable.

### 2. Description of Related Art

Termination of a power cable involves stripping the outer jacket and insulation from the conductor core. There are many different combinations of primary and secondary cable sizes—creating a need for an installer to be able to prepare numerous cable sizes blade housing on application needs, cable manufacturer and regional code requirements, and company specific installation instructions.

Some tools are built for application-specific purposes. They have one blade setting and one bore size specific to the cable geometry. These tools are narrowed in usability and not conducive to working across a range of sizes.

Other preparation tools are more flexible and utilize interchangeable bushings to allow the same basic tool frame to work across a range of application needs. Specifically, sized bushings are used for different cable sizes within the same tool frame. Every time a worker changes to a different application, they must change the bushing in their tool. This can be time consuming and cause delays if the correct bushing is not available. Typically, tools utilizing interchangeable bushings are only used for end stripping applications. A different tool must be used for midspan access, which further complicates the range of tools the end user must utilize for a full range of cable preparation.

Adjustable tools are opposed to bushing/fixed tool designs are blade housing on a configurable platform to accommodate different cable diameters and insulation thicknesses with one tool. These designs have a limitation on cable diameter range and tend to require more than one cable support member size as the end user transitions from smaller to larger cable sizes. The blade depth is limited as the cable diameter changes.

Tools on the market may incorporate a cable support member that is 180° from a blade. In these tools, as the cable diameter changes, the relative contact point between the blade and the cable changes, resulting in variable cutting action and depth, and requiring adjustment of the blade set.

Another limitation with existing tools having cable support members is that the reaction force created as the blade cuts through the cable is not directly supported. Instead, reaction force has components from the angle support causing cable shifting from the blade, resulting in an unstable cut. This also causes the cable to lose proper alignment within the cable support member.

On the cable support member tool, the clamping force must be higher to keep the cable positioned in the tool. The resulting rotational friction of the cut is increased. Higher clamping force equates to higher friction and poorer tool stability, making it harder to perform the stripping operation. Often, the adjustable platform needs to be repositioned during the cut to re-establish the clamping force on the cable, or the cable support member must be retightened during the cut since the set-up becomes unstable and loosens when trying to make aggressive cuts. The resulting performance of the tool is unstable and difficult to keep the blade tracking in a consistent direction relative to the cable. This results in poor cut quality. Unintentional damage to the conductor core may also result. Since the cable support member will not work across a wide range of diameters, the tool needs to be changed to a larger cable support member as the cable diameter increases.

Many tools on the market also utilize a fixed blade tracking (feed) angle, requiring an external supporting stop at the end of cut to get a clean square cut.

### SUMMARY OF THE INVENTION

It would therefore be useful to have an adjustable cutting tool for cable sheathing that allows for variable openings, blade depth adjustment, and blade tracking (feed) angle so the end user can adjust the feed for the application. The single adjustable tool will allow the end user to accomplish the same as a fixed tool with bushings. The same tool can also be used for end stripping and midspan stripping cable preparation.

Bearing in mind the problems and deficiencies of the prior art, it is therefore an object of the present invention to provide a cutting tool for cable sheathing which provides for an adjustment feature for adjusting cable diameter to ensure proper scoring.

It is another object of the present invention to provide a cutting tool for cable sheathing which is efficient in setting up the tool for scoring a cable.

A further object of the invention is to provide a stripping tool which provides for a clean removal of a cable.

Another object of the present invention is to provide a cutting tool for cable sheathing in which the blade is adjustable in different directions to score the cable in a lateral direction, in a perpendicular direction, or in a spiral direction along the length of the cable.

A further object of the invention is to provide a cutting tool for cable sheathing that allows for quick sliding and tightening of the cutting cable support member height.

It is yet another object of the present invention to provide a cutting tool for cable sheathing that has a moveable cable support member assembly for improving tool clearance while rotating the tool about a cable.

Still other objects and advantages of the invention will in part be obvious and will in part be apparent from the specification.

The above and other objects, which will be apparent to those skilled in the art, are achieved in the present invention which is directed to a tool for scoring a length of cable having a thickness. The scoring tool comprises a blade housing assembly having an opening and a blade assembly attached within the opening, the blade assembly including a sleeve and a blade secured in the sleeve. The scoring tool includes a cable support member assembly moveable towards and away from the blade housing assembly for securing the scoring tool to the cable. The blade is adjustable towards or away from the cable support member assembly for controlling the score depth into the thickness of the length of cable. The blade is adjustable in different directions while the scoring the thickness of the length of cable to provide for lateral or spiral incisions within the length of cable.

The blade housing assembly opening may be circular and the blade assembly may include an upper portion and a lower portion rotatable within the blade housing assembly opening, the angular position of the blade assembly determining the direction of score on the cable sheathing. The upper portion of the blade assembly may include a blade adjustment knob 69 for adjusting the blade depth relative to the blade holder. The blade assembly may be rotatable to a first position which guides the scoring tool along the cable in a spiral direction when the device is rotated about the cable and to a second position which guides the scoring tool around the cable preventing lateral movement of the scoring tool along the cable when the scoring tool is rotated about the cable. The blade assembly may be rotatable to a third position which guides the scoring tool along the cable in a lateral direction.

The scoring tool may include an adjustment frame located between the cable support member assembly and the blade assembly for adjusting distance between the cable support member and the tool body to accommodate different cable diameters, the adjustment frame relatively moving the cable support member assembly and the blade assembly with respect to each other such that the blade always contacts the cable insulation at a cut point diametrically opposite the second position.

The present invention also provides a method for using a scoring tool comprising providing a length of the cable having a cable sheathing with a thickness. The method includes providing a scoring tool comprising a blade housing assembly having an opening and a blade assembly attachable within the opening, the blade assembly including a sleeve and a blade secured in the sleeve, a cable support member assembly moveable toward and away from the blade housing assembly for securing the scoring tool to the cable. The method includes urging the cable support member assembly away from the blade housing assembly to a position whereby the cable may be inserted into the cable support member assembly, inserting the cable into the cable support member assembly and releasing the cable support member assembly until the blade assembly contacts the cable. The method may include ensuring the blade assembly is in a first position for scoring the cable sheathing in a desired first direction and embedding the blade into the cable sheathing to a desired depth into the thickness of the cable sheathing. The method may include moving the scoring tool in the first direction to score the cable and without removing the blade from the cable, rotating the blade assembly to a second position for scoring the cable in a desired second direction. The method may include moving the scoring tool in the second direction to score the cable, removing the scoring tool from the cable and removing the scored section of cable sheathing from the cable. The blade assembly may be rotatable to a first position which guides the scoring tool along the cable in a spiral direction when the device is rotated about the cable and to a second position which guides the scoring tool around the cable preventing lateral movement of the scoring tool along the cable when the scoring tool is rotated about the cable. The desired blade position may be the first position and the step of moving the scoring may include rotating the scoring tool about the cable, scoring the cable sheathing in a spiral direction. The blade assembly may be rotatable to a third position which guides the scoring tool about the cable in a lateral direction. The desired position may be the third position and the step of moving the scoring tool may include moving the scoring tool in a lateral direction. The desired position may be the second position and the step of moving the tool may include rotating the scoring tool about the cable and subsequently rotating the blade assembly to the third position and moving the scoring tool in a lateral direction prior to removing the scored section of cable sheathing from the cable.

Another aspect of the present invention is directed to a tool for scoring cable sheathing on a cable including a blade housing assembly having a blade housing, a blade housing opening, a blade disposed in the blade housing opening and a blade housing carrier having a blade housing carrier opening wherein the blade housing is rotatably secured in the blade housing carrier opening. The tool includes a cable support member moveable towards and away from the blade housing assembly and an adjustable frame disposed between the cable support member and the blade housing assembly for adjusting the cable support member toward and away from the blade housing assembly for scoring various diameter cables, the blade housing carrier secured to one end of the adjustable frame. The blade is adjustable within the blade housing opening toward and away from the cable support member for controlling a depth of the blade into the cable sheathing. The blade is rotatable for scoring the sheathing in a circular, lateral or spiral direction. The adjustable frame may include an adjustment rod rotatably secured to the blade housing carrier, the adjustment rod extending through the cable support member for moving the cable support member toward and away from the blade housing assembly. The tool may include an adjustment knob 69 disposed on an end of the adjustment rod wherein rotating the adjustment knob 69 in one direction moves the cable support member toward the blade housing assembly and rotating the adjustment knob 69 in a second direction opposite the one direction moves the cable support member away the blade housing assembly. The blade housing assembly may include a blade sleeve disposed in the blade housing opening for supporting the blade in the blade housing. The blade assembly may be rotatable to a first position which guides the scoring tool along the cable in a spiral direction when the device is rotated about the cable and to a second position which guides the scoring tool around the cable preventing lateral movement of the scoring tool along the cable when the scoring tool is rotated about the cable. The blade assembly may be rotatable to a third position which guides the scoring tool along the cable in a lateral direction. The adjustment rod may be threaded for adjustably moving the cable support member toward and away from the blade housing assembly. The tool may include an adjustment knob 69 secured to an end of the threaded adjustment rod wherein rotating the adjustment know rotates the threaded adjustment rod, moving the cable support member toward or away from the blade housing assembly. The tool may include a rotational locking screw adjustable in the blade assembly for locking the blade assembly in the blade housing opening.

Another aspect of the present invention is directed to a method of scoring a cable sheathing. The method includes providing a tool for scoring cable sheathing on a cable, the tool having a blade housing assembly including a blade housing, a blade housing opening, a blade disposed in the blade housing opening and a blade housing carrier having a blade housing carrier opening wherein the blade housing is rotatably secured in the blade housing carrier opening, the tool including a cable support member moveable towards and away from the blade housing assembly and an adjustable frame disposed between the cable support member and the blade housing assembly for adjusting the cable support member toward and away from the blade housing assembly for scoring various diameter cables, the blade housing carrier secured to one end of the adjustable frame wherein the blade is adjustable within the blade housing opening toward and away from the cable support member for controlling a depth of the blade into the cable sheathing and wherein the blade is rotatable for scoring the sheathing in a circular, lateral or spiral direction. The method includes providing a cable having a sheathing, ensuring the tool in in an open position, placing the cable in the tool cable support member and moving the cable support member toward the tool blade housing until the blade housing contacts the cable sheathing. The method includes adjusting the direction of the blade to the desired angular direction, adjusting the blade in a depth direction toward the cable until the blade slices into the cable sheath to the desired depth and moving the cable to slice the cable sheathing. The method includes moving the cable support member away from the tool blade housing until the cable is releasable from the cable support member and releasing the cable from the cable support member. The adjustable frame may include an adjustment rod rotatably secured to the blade housing assembly, the adjustment rod extending through the cable support member for moving the cable support member toward and away from the blade housing assembly. An adjustment knob 69 may be disposed on an end of the adjustment rod wherein rotating the adjustment knob 69 in one direction moves the cable support member toward the blade housing assembly and rotating the adjustment knob 69 in a second direction opposite the one direction moves the cable support member away the blade housing assembly. An adjustment knob 69 may be secured to an end of the threaded adjustment rod wherein rotating the adjustment know rotates the threaded adjustment rod, moving the cable support member toward or away from the blade housing assembly. The step of adjusting the direction of the blade to the desired angular direction may include adjusting the direction of the blade to score the cable along the length of the cable and the step of moving the cable to slice the cable sheathing includes drawing the cable through the cable support member. The step of adjusting the direction of the blade to the desired angular direction may include adjusting the direction of the blade to score the cable about the diameter of the cable and the step of moving the cable to slice the cable sheathing includes rotating the cable in the cable support member. The step of adjusting the direction of the blade to the desired angular direction may include adjusting the direction of the blade to score the cable in a spiral along the length of the cable and the step of moving the cable to slice the cable sheathing includes drawing the cable through the cable support member while rotating the cable in the cable support member. The step of adjusting the direction of the blade to the desired angular direction ay include adjusting the direction of the blade to score the cable in a spiral along the length of the cable and the step of moving the cable to slice the cable sheathing includes drawing the cable through the cable support member while rotating the cable in the cable support member and subsequently adjusting the direction of the blade to score the cable about the diameter of the cable and rotating the cable in the cable support member wherein the cable sheath may be removed by unwinding the spiral after the cable is removed from the tool and the cable sheathing falls off the cable leaving a clean circular termination of the cable sheath a distance from the cable end.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a front right bottom perspective view of the cable scoring tool according to the present invention.

FIG. 2 is a rear left top perspective view of the cable scoring tool according to the present invention.

FIG. 3 is a front left bottom perspective view of the cable scoring tool according to the present invention.

FIG. 4 is a front elevational view of a method step of using the cable scoring tool according to the present invention.

FIG. 5 is a front elevational view of another method step of using the cable scoring tool according to the present invention.

FIG. 6 is a front elevational view of another method step of using the cable scoring tool according to the present invention.

FIG. 7 is a front right bottom perspective view of another embodiment of the cable scoring tool according an embodiment of the present invention.

FIG. 8 is a front right top perspective view of the cable scoring tool of FIG. 7.

FIG. 9 is a front left bottom perspective view of the cable scoring tool of FIG. 7.

FIG. 10 is a front left top perspective view of the cable scoring tool of FIG. 7.

FIG. 11 is a right elevational view of the cable scoring tool of FIG. 7.

FIG. 12 is a top plan view of the cable scoring tool of FIG. 7.

FIG. 13 is a perspective view of the upper rotatable portion of the blade assembly of the cable scoring tool of FIG. 7.

FIG. 14 is a perspective view of the lower rotatable portion of the blade assembly of the cable scoring tool of FIG. 7.

FIG. 15 is a perspective view of the jaw assembly of the cable scoring tool of FIG. 7.

FIG. 16 is an exploded perspective view of the clamping screw knob of the cable scoring tool of FIG. 7.

FIG. 17 is a perspective view of the clamping screw and knob of the cable scoring tool of FIG. 7.

FIG. 18 is an exploded perspective view of the blade assembly of the cable scoring tool of FIG. 7.

FIG. 19 is a perspective view of the base assembly of the cable scoring tool of FIG. 7.

FIG. 20 is cross sectional perspective view of the blade housing assembly of the cable scoring tool of FIG. 7.

FIG. 21 is a front elevational view of a cable having been scored for spiral peeling.

FIG. 22 is a front elevational view of a cable having been scored for longitudinal peeling.

### DESCRIPTION OF THE EMBODIMENT(S)

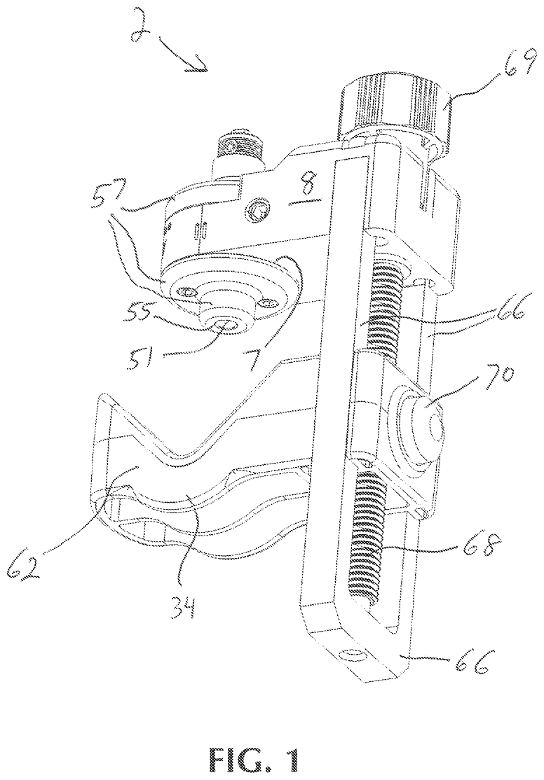

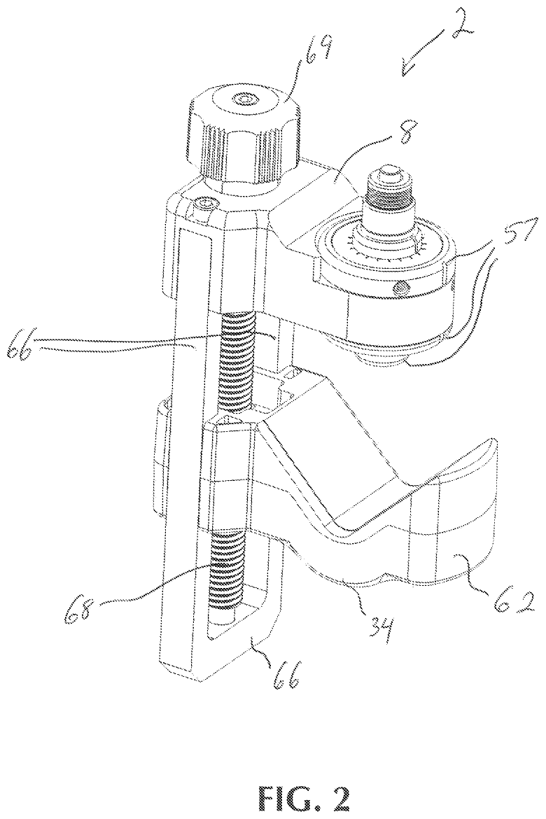

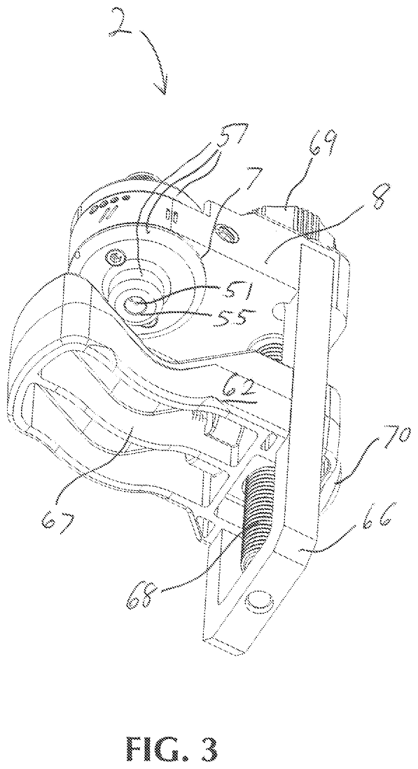

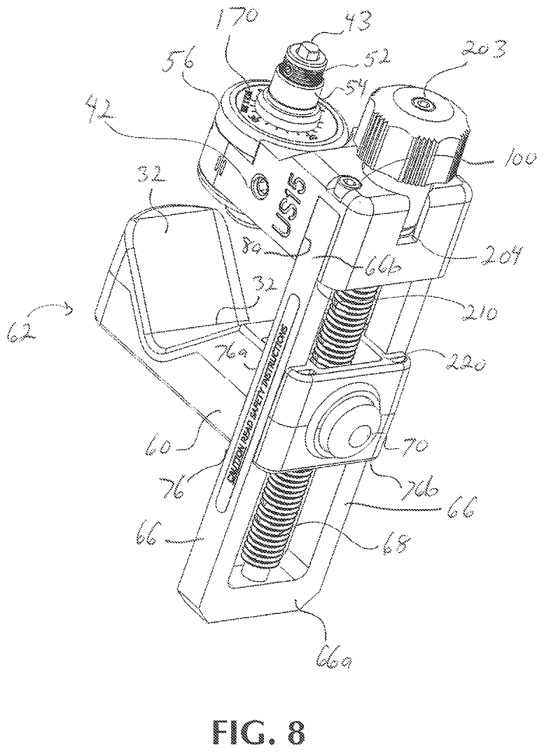

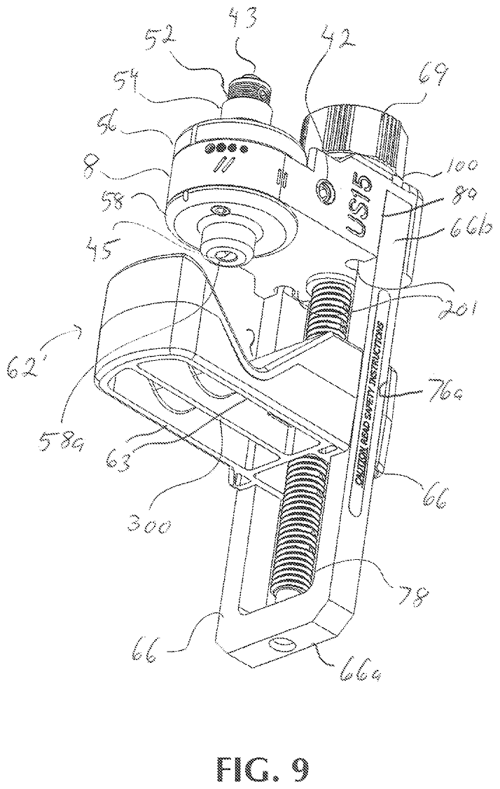

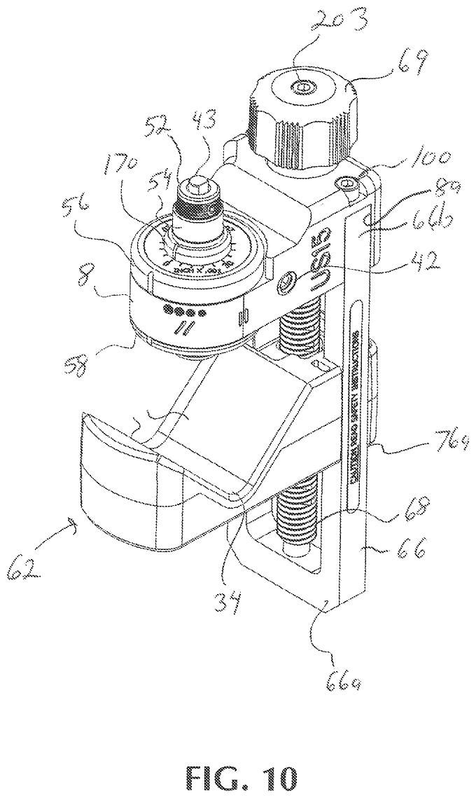

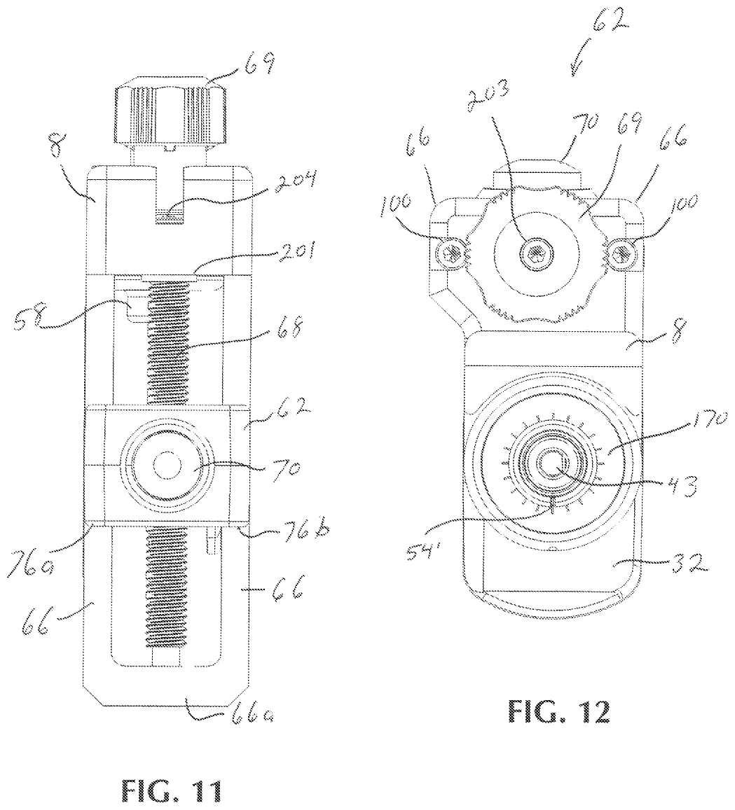

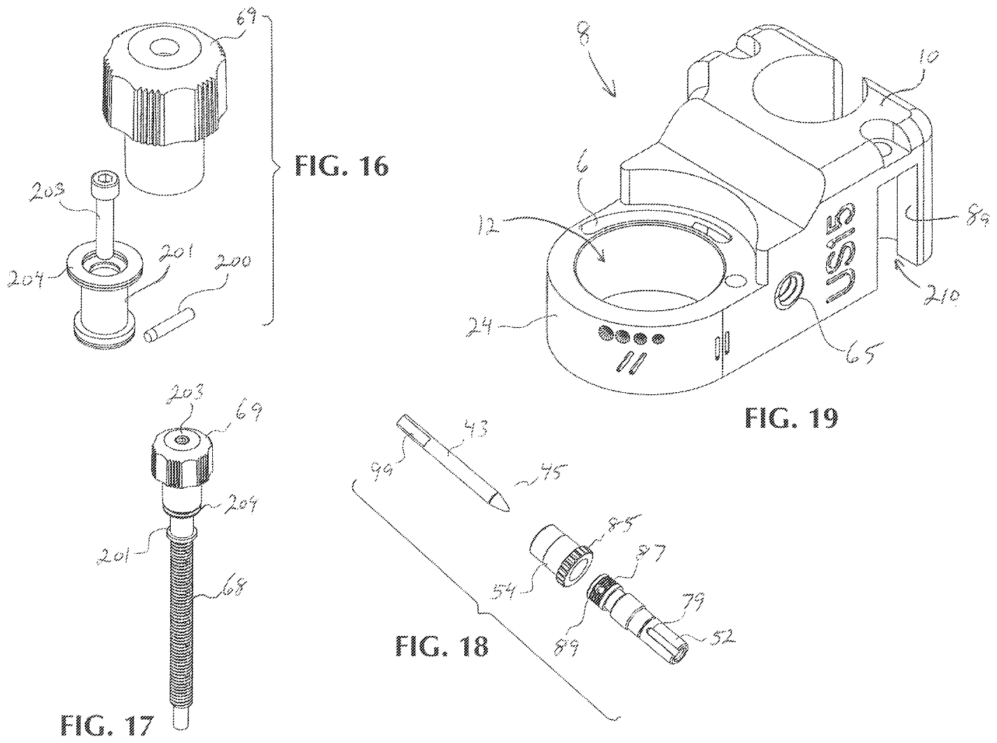

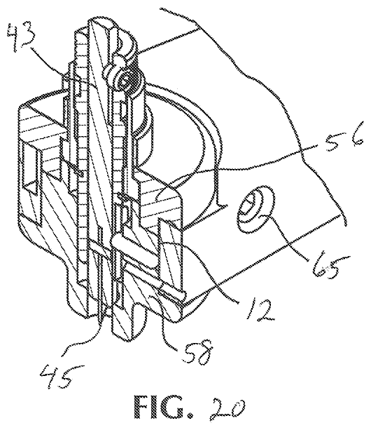

In describing the embodiment of the present invention, reference will be made herein to FIGS. 1-22 of the drawings in which like numerals refer to like features of the invention.

The present invention as shown in FIGS. 1-3 is a tool for scoring cable sheathing on a cable 22. The tool 2 includes a blade housing assembly having a blade housing 57, a blade housing opening 55, a blade 51 disposed in the blade housing opening 55 and a blade housing carrier 8 having a blade housing carrier opening 7 wherein the blade housing 57 is rotatably secured in the blade housing carrier opening 7. The tool 2 includes a cable support member 62 moveable towards and away from the blade housing assembly and an adjustable frame 66 disposed between the cable support member 62 and the blade housing assembly for adjusting the cable support member 62 toward and away from the blade housing assembly for scoring various diameter cables, the blade housing carrier 8 secured to one end of the adjustable frame 66. The cable support member 62 includes a curved portion 34 for support of the cable support member 62. The curved portion 34 provides strength against breakage as well bending during use. An additional spline 67 in the cable support member provides additional support. The blade 51 is adjustable within the blade housing opening 55 toward and away from the cable support member 62 for controlling a depth of the blade 51 into the cable sheathing. The blade 51 is rotatable for scoring the sheathing in a circular, lateral or spiral direction.

The adjustable frame 66 may include an adjustment rod 68 rotatably secured to the blade housing carrier 8, the adjustment rod 68 extending through the cable support member 62 for moving the cable support member 62 toward and away from the blade housing assembly. The tool 2 may include an adjustment knob disposed on an end of the adjustment rod 68 wherein rotating the adjustment knob in one direction moves the cable support member 62 toward the blade housing assembly and rotating the adjustment knob in a second direction opposite the one direction moves the cable support member 62 away the blade housing assembly. The blade housing assembly may include a blade sleeve disposed in the blade housing opening 55 for supporting the blade 51 in the blade housing 57. The blade assembly may be rotatable to a first position which guides the scoring tool 2 along the cable in a spiral direction when the device is rotated about the cable and to a second position which guides the scoring tool 2 around the cable preventing lateral movement of the scoring tool 2 along the cable when the scoring tool 2 is rotated about the cable 22. The blade assembly may be rotatable to a third position which guides the scoring tool 2 along the cable in a lateral direction.

The adjustment rod 68 may be threaded for adjustably moving the cable support member 62 toward and away from the blade housing assembly. the cable support member includes a thread release button 70 to allow slideable coarse adjustment of the cable support member toward and away from the blade housing assembly. The tool 2 may include an adjustment knob secured to an end of the threaded adjustment rod 68 wherein rotating the adjustment know rotates the threaded adjustment rod 68, moving the cable support member 62 toward or away from the blade housing assembly. The tool 2 may include a rotational locking screw adjustable in the blade assembly for locking the blade assembly in the blade housing opening 55.

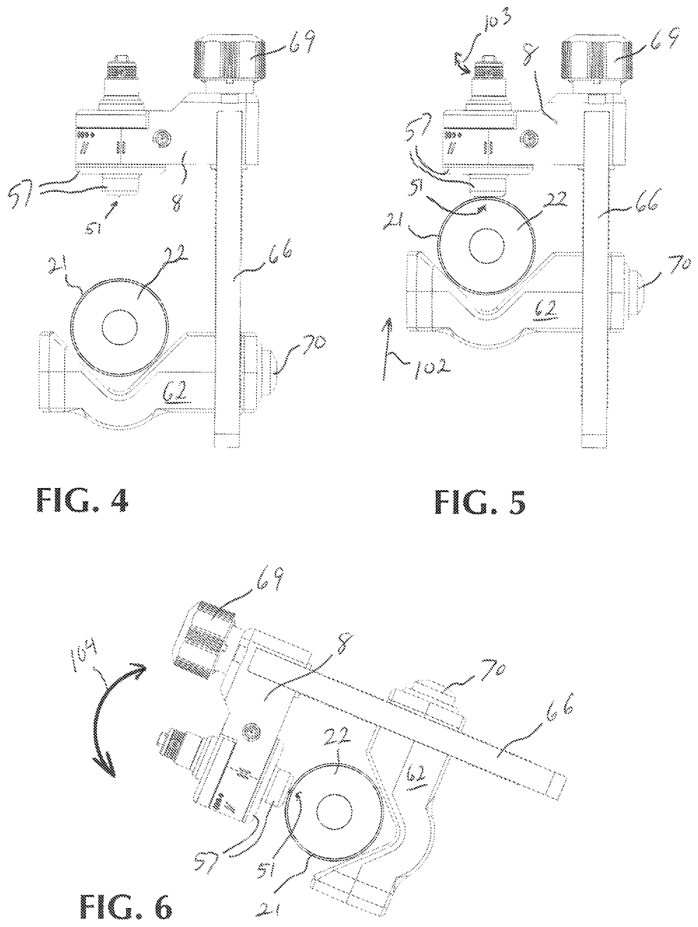

Another aspect of the present invention is directed to a method of scoring a cable sheathing as shown in FIGS. 4-6. The method includes providing a tool 2 for scoring cable sheathing on a cable, the tool 2 having a blade housing assembly including a blade housing 57, a blade housing opening 55, a blade 51 disposed in the blade housing opening 55 and a blade housing carrier 8 having a blade housing carrier opening 7 wherein the blade housing is rotatably secured in the blade housing carrier opening 7, the tool 2 including a cable support member 62 moveable towards and away from the blade housing assembly and an adjustable frame 66 disposed between the cable support member 62 and the blade housing assembly for adjusting the cable support member 62 toward and away from the blade housing assembly for scoring various diameter cables, the blade housing carrier 8 secured to one end of the adjustable frame 66 wherein the blade 51 is adjustable within the blade housing opening 55 toward and away from the cable support member 62 for controlling a depth of the blade 51 into the cable sheathing and wherein the blade 51 is rotatable for scoring the sheathing in a circular, lateral or spiral direction.

The method includes providing a cable 22 having a sheathing 21, ensuring the tool 2 in an open position and placing the cable 22 in the tool 2 cable support member 62 as shown in FIG. 4. The method includes moving the cable support member 62 in the direction of arrow 102 toward the tool 2 blade housing 57 until the blade housing 57 contacts the cable sheathing 21. The method includes adjusting the direction of the blade 51 (arrow 103) to the desired angular direction, adjusting the blade 51 in a depth direction toward the cable until the blade 51 slices into the cable sheath 21 to the desired depth and moving the cable 22 to slice the cable sheathing 21.

If the cable sheathing 21 is to be sliced along the cable length, the cable is drawn along its length as in FIG. 5. If the cable sheathing 21 is to be sliced about the cable diameter, the tool 2 is rotated around the cable 22 in the direction of arrow 104 as shown in FIG. 6. If the cable sheathing 21 is to be sliced in a spiral direction, the blade is set to an angle between the lateral slicing direction and the rotational direction, the tool 2 is rotated around the cable 22 in the direction of arrow 104 while being drawn along the cable length as shown in FIG. 6. The method includes moving the cable support member 62 away from the tool 2 blade housing 57 until the cable is releasable from the cable support member 62 and releasing the cable from the cable support member 62. The adjustable frame 66 may include an adjustment rod 68 rotatably secured to the blade housing assembly, the adjustment rod 68 extending through the cable support member 62 for moving the cable support member 62 toward and away from the blade housing assembly. An adjustment knob may be disposed on an end of the adjustment rod 68 wherein rotating the adjustment knob in one direction moves the cable support member 62 toward the blade housing assembly and rotating the adjustment knob in a second direction opposite the one direction moves the cable support member 62 away the blade housing assembly.

An adjustment knob may be secured to an end of the threaded adjustment rod 68 wherein rotating the adjustment know rotates the threaded adjustment rod 68, moving the cable support member 62 toward or away from the blade housing assembly. The step of adjusting the direction of the blade 51 to the desired angular direction may include adjusting the direction of the blade 51 to score the cable along the length of the cable and the step of moving the cable to slice the cable sheathing includes drawing the cable through the cable support member 62. The step of adjusting the direction of the blade 51 to the desired angular direction may include adjusting the direction of the blade 51 to score the cable about the diameter of the cable and the step of moving the cable to slice the cable sheathing includes rotating the cable in the cable support member 62. The step of adjusting the direction of the blade 51 to the desired angular direction may include adjusting the direction of the blade 51 to score the cable in a spiral along the length of the cable and the step of moving the cable to slice the cable sheathing includes drawing the cable through the cable support member 62 while rotating the cable in the cable support member 62. The step of adjusting the direction of the blade 51 to the desired angular direction ay include adjusting the direction of the blade 51 to score the cable in a spiral along the length of the cable and the step of moving the cable to slice the cable sheathing includes drawing the cable through the cable support member 62 while rotating the cable in the cable support member 62 and subsequently adjusting the direction of the blade 51 to score the cable about the diameter of the cable and rotating the cable in the cable support member 62 wherein the cable sheath may be removed by unwinding the spiral after the cable is removed from the tool and the cable sheathing falls off the cable leaving a clean circular termination of the cable sheath a distance from the cable end.

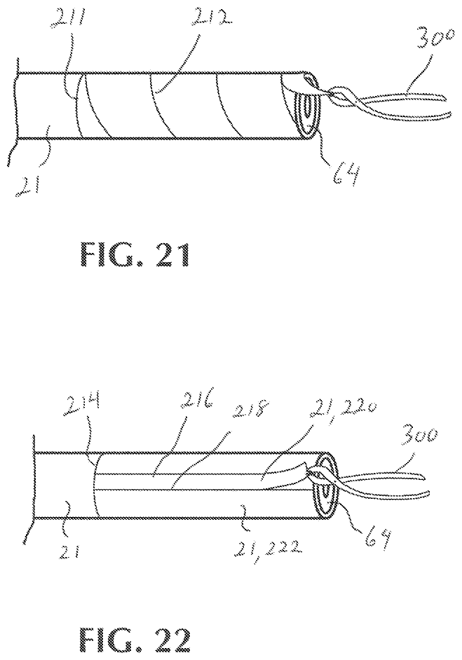

Referring to FIG. 21, once the sheathing 21 has been scored in a rotational direction at score 211 and then spirally at score 212, a set of pliers 300 may be used to grasp the end of the scored semi-con layer 21′ and peeled from the insulation layer 64 until the peeled portion of the semi-con layer 21′ reaches score 211. The peeled sheathing 21′ breaks cleanly from the insulation layer 64 at score 211. Alternately, a technician may use his fingers to peel the scored semi-con.

Referring to FIG. 22 once the jacket 21 has been scored in a rotational direction at score 214 and then horizontally on at least one of scores 216 and 218, the set of pliers 200 may be used to grasp the end of the scored semi-con layer portion 220 and peeled from the insulation layer 64 until the sheathing portion 220 is peeled extending to score 214. The peeled jacket 220 breaks cleanly from the insulation layer 64 at score 214. The remainder of the jacket portion 222 may then be peeled using pliers 300. Alternately, a technician may use his fingers to peel the scored semi-con.

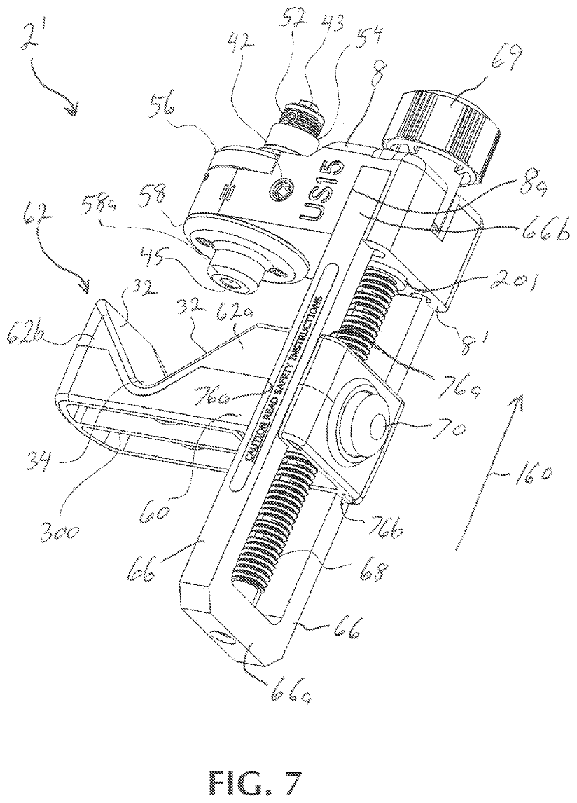

In another embodiment of the present invention as shown in FIGS. 7-12, the cable cutting tool 2 includes a blade housing assembly 8, a blade housing assembly opening 12 in the blade housing assembly 8, and blade assembly 48 rotatably secured in the blade housing assembly opening 12. The cutting tool 2 includes a blade sleeve 52, a blade tip 45, and a blade shaft 43 secured in the blade sleeve 52. Sliding posts 66 extend from the blade housing assembly 8 and a cable support member assembly 62 is slidingly attached to the sliding posts 66 through guide openings 76 on the cable support member assembly 62.

The sliding cable support member 62 is located on sliding platform frame 60 and has a first cable support member portion 62a and a second cable support member portion 62b, oriented at approximately a 90° angle. Cable support member 62 is guided by sliding posts 66 extending from blade housing assembly 8 through sliding platform 60 for tracking stability and anti-rotation. The sliding cable support member 62 slides along the axis of the sliding posts 66 in a line of movement 160.

The cable support member assembly 62 includes inclined surfaces 32. The included surfaces 32 are at an angle to one another whereby the channel or groove 34 extends lengthwise sufficient to allow a cable 22 to securely lie in the length of the groove 34.

A threaded adjustment rod 68 and threaded adjustment rod knob 69 allows the cable support member 62 to be tightened and generate clamping force once it is in contact with the cable 22. For small cable support member movements, the threaded adjustment rod 68 can be turned to move the cable support member along the axis 160 of the sliding posts 66. For large cable support member travel increments, a quick position feature is included. The spring-loaded quick position button 70 can be pressed to allow the cable support member 62 to freely travel along the posts until it meets the cable 22. The end user can then turn the threaded adjustment rod knob 69 to create the clamping pressure the quick position button 70 can also be used to allow quick releasing from the cable.

Threaded adjustment rod 68 also includes threaded adjustment rod blade housing 201 seated so that the bottom portion 8′ of blade housing assembly 8 is in communication with threaded adjustment rod blade housing 201. Threaded adjustment rod knob 69 is secured to the threaded adjustment rod 68 with screw knob fastener 203 and pin 200 located within threaded adjustment rod 68. Washer 204 are seated between threaded adjustment rod blade housing 201 and threaded adjustment rod knob 69.

The blade assembly 48 includes a height adjustment knob 54, a blade sleeve 52, a blade shaft 43 and a blade tip 45. The blade assembly 48 extends through the upper rotatable portion 56 and the opening 28 of the lower rotatable portion 58, the upper rotatable portion rotatably engaged with the upper portion of the blade housing assembly central opening 12 and the lower rotatable portion 58 rotatably engaged with a lower portion of the blade housing assembly central opening 12.

The upper rotatable portion 56 may include a height adjustment spring and a height adjustment bearing in contact with the height adjustment spring. The height adjustment bearing is urged against the teeth 85 of the height adjustment knob 54, allowing the height adjustment knob to be rotated in discrete steps which correspond to specific blade height changes.

A lower rotatable portion pin 77 extending through the lower rotatable portion 58 is engaged with a blade sleeve groove 79, setting the blade sleeve 52 in a fixed position with respect to the upper rotatable portion 56 and the lower rotatable portion 58.

The blade housing assembly 8 may include a direction adjustment spring 169 and a direction adjustment bearing 167 urging against direction indents 91 on the upper rotatable portion 56. The direction adjustment bearing 167 and direction indents 91 allow the upper rotatable portion 56 and lower rotatable portion 58 to be rotated in discrete steps.

The blade housing assembly 8 may include a calibration set screw 42 engageable with threaded opening 65. The rotation of calibration set screw 42 urges the upper rotatable portion 56 and the lower rotatable portion 58 to a direction fixed by the calibration set screw 61 position. This calibration may allow for squaring of rotatable portion 56 and lower rotatable portion 58.

Turning now to the top pan view of FIG. 12, the blade housing assembly 8 includes a blade depth indicator 170 and depth indicator detent 54′. Top fasteners 100 are located on opposing sides of blade housing assembly 8 between screw knob 69. Top fasteners 100 secure sliding posts 66 to the blade housing assembly 8. Screw knob fastener 203 secures screw knob 69 to threaded adjustment rod 68 (not shown). The spring-loaded quick release button 70 is located at the end opposing blade holder 43.

The cable support member assembly 62 is adjustably secured to the adjustment frame 66 and threaded adjustment rod 68. The adjustment frame is placed at a terminal end of cable support member assembly, opposite the inclined surfaces 32 on the cable support member assembly outer surface 62b. Guide openings 76 engage adjustment frame 66 at three points of contact. Threaded adjustment rod 68 is displaced between the guide openings 76 and is received through an opening 66′ located within adjustment frame 66. Spring-loaded quick release button 70 protrudes from quick release opening 222 while in contact with threaded adjustment rod 68. After pressing quick release button 70, cable support member assembly 62 is slideable moveable within threaded adjustment rod 68 through cable support member screw opening 221 (see also FIG. 15). As cable support member assembly 62 is moved it is supported by adjustment frame 66 due to guide opening 76 maintaining three points of contact with adjustment frame 66.

Cable support member frame support 300 provides additional rigidity cable support member assembly 62 to maintain the angle of inclined surfaces 32. As a result, the interior of cable support member assembly 62 may largely be empty to reduce the material needed for the structural integrity of cable support member assembly 62.

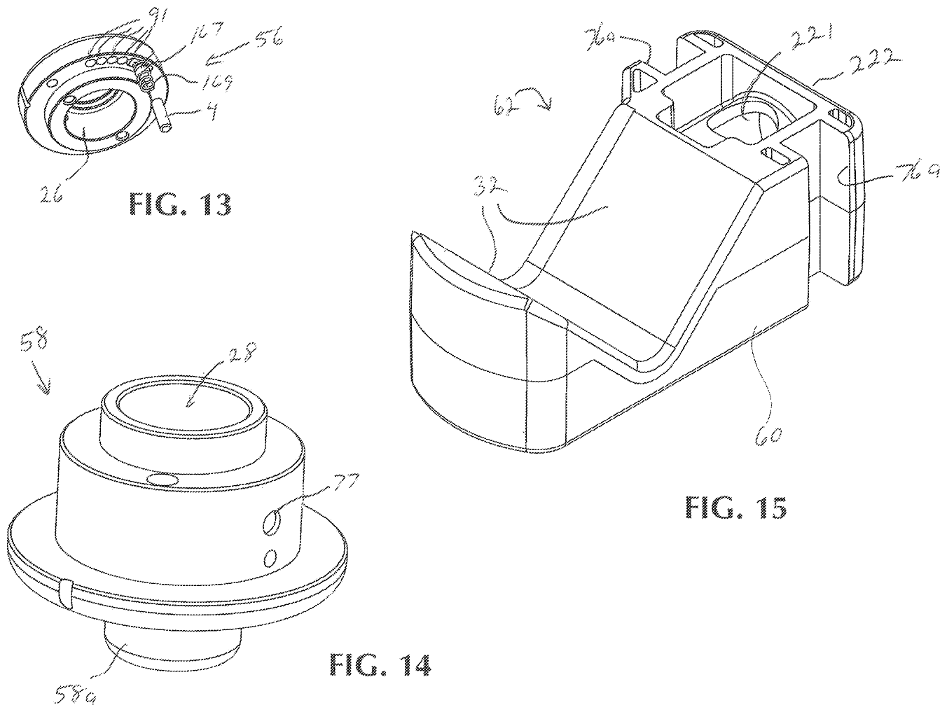

As shown in FIG. 13, the direction adjustment spring 169 and direction adjustment bearing 167 urges against direction indents 91 on upper rotatable portion 56. Pin 4 allows for contact of set screw 42, allowing the squaring of upper portion 56 with bottom portion 58.

The blade assembly 48 is rotatably secured within blade housing assembly 8. A height adjustment spring 73 is in contact with a height adjustment bearing 71. The height adjustment bearing 71 is urged against teeth 85 of the height adjustment knob 54, allowing the height adjustment knob 54 to be rotated in discrete steps which may correspond to specific blade heights. The end user may not these heights blade housing on a marked position on blade depth indicator 170.

The lower rotatable portion pin 77 is extended through the lower rotatable portion 58 (see FIG. 14) and is engaged with the blade sleeve groove 79, preventing movement of blade sleeve 52. The end user may thereby turn height adjustment knob 54 to increase or decrease the depth of blade tip 45 protruding from lower rotating portion 58A.

The cable support member 62 may further include a curved portion 34a located between first cable support member portion 62a and second cable support member portion 62b. The curved portion is located on both sides of the frame of cable support member 62 and on the cable support member frame support 300. The addition of curved portion 34a further increases the structural integrity of cable support member assembly 62, increasing the maximum load on the cable support member assembly 62 by a cable 22 during a cut in operation of the cable sheathing tool.

Thus, the present invention provides one or more of the following advantages: a sliding cable support member to secure a cable, the cable support member including a spring-loaded quick release mechanism; a cutting blade with variable depth adjustment and depth indicator; and variable blade cutting directions, allowing the blade to cut a cable sheathing in circular orientation, spiral orientation, or longitudinal orientation.

While the present invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A tool for scoring cable sheathing on a cable comprising:
a blade housing assembly having:
a blade housing;
a blade housing opening;
a blade disposed in the blade housing opening; and
a blade housing carrier having a blade housing carrier opening wherein the blade housing is rotatably secured in the blade housing carrier opening;
a cable support member moveable towards and away from the blade housing assembly;
an adjustable frame disposed between the cable support member and the blade housing assembly for adjusting the cable support member toward and away from the blade housing assembly for scoring various diameter cables, the blade housing carrier secured to one end of the adjustable frame; and
a threaded adjustment rod rotatably secured to the blade housing carrier, the adjustment rod extending through a female threaded opening in the cable support member, the female threaded opening engagable with the threaded adjustment rod whereby rotating the threaded adjustment rod moves the cable support member toward or away from the blade housing assembly;
wherein the blade is adjustable within the blade housing opening toward and away from the cable support member for controlling a depth of the blade into the cable sheathing, and
wherein the blade is rotatable for scoring the sheathing in a circular, lateral or spiral direction.

2. The tool according to claim 1 wherein the cable support member includes a thread release button to allow slideable coarse adjustment of the cable support member toward and away from the blade housing assembly.

3. The tool according to claim 1 including an adjustment knob disposed on an end of the adjustment rod wherein rotating the adjustment knob in one direction moves the cable support member toward the blade housing assembly and rotating the adjustment knob in a second direction opposite the one direction moves the cable support member away the blade housing assembly.

4. The tool according to claim 1 wherein the cable support member includes a first and second surface secured at an angle to one another and including a reinforcement portion for strengthening connecting edges of the first and second surfaces.

5. The scoring tool of claim 1 wherein the blade assembly is rotatable to a first position which guides the scoring tool along the cable in a spiral direction when the device is rotated about the cable and to a second position which guides the scoring tool around the cable preventing lateral movement of the scoring tool along the cable when the scoring tool is rotated about the cable.

6. The scoring tool of claim 5 wherein the blade assembly is rotatable to a third position which guides the scoring tool along the cable in a lateral direction.

7. The scoring tool of claim 2 wherein the adjustment rod is threaded for adjustably moving the cable support member toward and away from the blade housing assembly.

8. The scoring tool of claim 7 including an adjustment knob secured to an end of the threaded adjustment rod wherein rotating the adjustment know rotates the threaded adjustment rod, moving the cable support member toward or away from the blade housing assembly.

9. The scoring tool of claim 1 including a rotational locking screw adjustable in the blade assembly for locking the blade assembly in the blade housing opening.

10. The scoring tool of claim 1 wherein the blade housing assembly includes a blade sleeve disposed in the blade housing opening for supporting the blade in the blade housing.

11. A method of scoring a cable sheathing comprising:
providing a tool for scoring cable sheathing on a cable, the tool having a blade housing assembly including a blade housing, a blade housing opening, a blade disposed in the blade housing opening and a blade housing carrier having a blade housing carrier opening wherein the blade housing is rotatably secured in the blade housing carrier opening, the tool including a cable support member, an adjustable frame disposed between the cable support member and the blade housing assembly for adjusting the cable support member toward and away from the blade housing assembly for scoring various diameter cables, the blade housing carrier secured to one end of the adjustable frame and a threaded adjustment rod rotatably secured to the blade housing carrier, the adjustment rod extending through a female threaded opening in the cable support member, the female threaded opening engagable with the threaded adjustment rod whereby rotating the threaded adjustment rod moves the cable support member toward or away from the blade housing assembly wherein the blade is adjustable within the blade housing opening toward and away from the cable support member for controlling a depth of the blade into the cable sheathing and wherein the blade is rotatable for scoring the sheathing in a circular, lateral or spiral direction;
providing a cable having a sheathing;
ensuring the tool in in an open position;
placing the cable in the tool cable support member;
moving the cable support member toward the tool blade housing until the blade housing contacts the cable sheathing;
adjusting the direction of the blade to the desired angular direction;
adjusting the blade in a depth direction toward the cable until the blade slices into the cable sheath to the desired depth;
moving the cable to slice the cable sheathing;
moving the cable support member away from the tool blade housing until the cable is releasable from the cable support member; and
releasing the cable from the cable support member.

12. The method of scoring a cable sheathing according to claim 11 wherein the adjustable frame includes an adjustment rod rotatably secured to the blade housing assembly, the adjustment rod extending through the cable support member for moving the cable support member toward and away from the blade housing assembly.

13. The method of scoring a cable sheathing according to claim 11 including an adjustment knob disposed on an end of the adjustment rod wherein rotating the adjustment knob in one direction moves the cable support member toward the blade housing assembly and rotating the adjustment knob in a second direction opposite the one direction moves the cable support member away the blade housing assembly.

14. The method of scoring a cable sheathing according to claim 11 including an adjustment knob secured to an end of the threaded adjustment rod wherein rotating the adjustment know rotates the threaded adjustment rod, moving the cable support member toward or away from the blade housing assembly.

15. The method of scoring a cable sheathing according to claim 11 wherein the step of adjusting the direction of the blade to the desired angular direction includes adjusting the direction of the blade to score the cable along the length of the cable and the step of moving the cable to slice the cable sheathing includes drawing the cable through the cable support member.

16. The method of scoring a cable sheathing according to claim 11 wherein the step of adjusting the direction of the blade to the desired angular direction includes adjusting the direction of the blade to score the cable about the diameter of the cable and the step of moving the cable to slice the cable sheathing includes rotating the cable in the cable support member.

17. The method of scoring a cable sheathing according to claim 11 wherein the step of adjusting the direction of the blade to the desired angular direction includes adjusting the direction of the blade to score the cable in a spiral along the length of the cable and the step of moving the cable to slice the cable sheathing includes drawing the cable through the cable support member while rotating the cable in the cable support member.

18. The method of scoring a cable sheathing according to claim 11 wherein the step of adjusting the direction of the blade to the desired angular direction includes adjusting the direction of the blade to score the cable in a spiral along the length of the cable and the step of moving the cable to slice the cable sheathing includes drawing the cable through the cable support member while rotating the cable in the cable support member and subsequently adjusting the direction of the blade to score the cable about the diameter of the cable and rotating the cable in the cable support member wherein the cable sheath may be removed by unwinding the spiral after the cable is removed from the tool and the cable sheathing falls off the cable leaving a clean circular termination of the cable sheath a distance from the cable end.

19. The method of scoring a cable sheathing according to claim 11 wherein the cable support member includes a thread release button to allow slideable coarse adjustment of the cable support member toward and away from the blade housing assembly and the step of moving the cable support member toward the tool blade housing until the blade housing contacts the cable sheathing includes depressing the button to slide the cable support member close to the blade housing assembly, releasing the button and rotating the threaded adjustment rod until the blade housing contacts the cable sheathing.
